(19) United States
(12) Patent Application Publication
(10) Pub. No.: US 2016/0253306 A1
(43) Pub. Date: Sep. 1, 2016

(54) THE METHOD OF INSERTING OBJECTS INTO A PDF DOCUMENT

(71) Applicant: Fujian Foxit Software Development Joint Stock Co., Ltd., Fuzhou (CN)

(72) Inventor: Xiaolong Fan, Beijing (CN)

(21) Appl. No.: 14/778,178

(22) PCT Filed: Mar. 14, 2014
(86) PCT No.: PCT/CN2014/000270

§ 371 Date: Sep. 18, 2015

(30) Foreign Application Priority Data
Mar. 19, 2013 (CN) 201310088526.5

(51) Int. Cl. G06F 17/24; G06F 17/21; G06F 3/0482; G06F 3/0484

(52) U.S. Cl. CPC G06F 17/245; G06F 3/0484; G06F 17/248; G06F 17/214; G06F 3/0482; G06F 17/212

(57) ABSTRACT

The present invention discloses a method for inserting objects into a PDF document, the method comprises the following steps: S1: collecting all manifestations of the objects to be inserted, and incorporating them into one configuration file; S2: establishing a mapping table, wherein the mapping table comprises indexes, and said indexes indicate the position of each expression form of the objects to be inserted in said configuration file; S3: creating an insert panel, opening said insert panel for a user to select or edit the objects to be inserted after the user issue an instruction of inserting object; and S4: closing said insert panel, and writing the contents edited by the user in the insert panel into the PDF document in the form of stream objects after the user issue a closing instruction. The method provided by the present invention can insert the mathematical formulas and special symbols directly into a PDF document, and modify them at any time according to the demand of users, which thereby greatly facilitates the user to operate on the formulas and special symbols, so that the efficiency of creating and editing a PDF document is enhanced.

### TECHNICAL FIELD

The present invention relates to a technical field of editing PDF document, in particular, which is related to a method of inserting objects in a PDF document.

### BACKGROUND

PDF is a very common file format; it is popular by more and more users for its unique security and excellent capabilities of cross-platform. However, the PDF can only be made a little simple modification through the Acrobat software provided by the authority, in the most circumstances the PDF has to be re-generated by re-editing the original files; therefore it is very difficult to be modified. Especially when document need to be inserted objects such as formulas or special characters, it is very inconvenient for the formulas or special characters cannot be inserted and edited in the prior art.

### SUMMARY OF THE INVENTION

The purpose of the present invention is to overcome the existing shortcomings of editing the PDF document, which provides a method of inserting formulas or special characters into a PDF document.

In order to achieve the purpose above, the present invention provides a method of inserting objects in PDF document, which comprises the following steps:

S1: collecting all manifestations of the objects to be inserted, and incorporating them into one configuration file;

S2: establishing a mapping table, which comprising indexes for use as wanting the positions of the each manifestation of the inserted objects in said configuration file;

S3: creating an insert panel, and after the user issues an instruction of inserting object,

Opening said insert panel for user to select or edit the objects to be inserted;

S4: after the user issues a closing instruction, closing said insert panel, and writing the contents edited in said edit panel by the user into the PDF document in the form of stream objects.

The method for inserting objects into the PDF document provided by the present invention, wherein, said objects are formulas, and their manifestations are all kinds of formula templates; said mapping table further including attributes, said attributes comprising formula attributes and general attributes; said formula attributes are used to determine formula structures, which comprising whether there are nests, the number of total nest layers and the corresponding index of sub-template of the each nest layer; Said general attributes comprising character pitch of the text, horizontal pantograph level, the array pitch, the font type of the text, the font size and the exhibition mode; the insert panel is an edit panel for the user to edit the formulas to be inserted.

The method for inserting objects into the PDF document provided by the present invention, wherein, said step S3 comprising:

S31: judging whether there is any nesting relationship in the current edited formula template, if there is no said nesting relationship, then according to said index to obtain each attribute corresponding to the current formula template from said configuration file and to feed back it to said user; if there is said nesting relationship, then after obtaining said each attribute of internal nest formula template, and in combination with external formula template again so as to adjust, and then feeding back the adjusted integrate attribute to the user.

The method for inserting objects into the PDF document provided by the present invention, wherein, said step S4 comprising:

S41: writing formula object identification before completing an edited formula, and then writing said formula object identification together with the edited formula into the PDF document in the form of stream objects. The method for inserting objects into the PDF document provided by the present invention, wherein, further comprising:

S5: revising the inserted formulas after the user issues a modifying instruction.

The method for inserting objects into the PDF document provided by the present invention, wherein, said step S5 comprising:

S51: extracting associated formula information stored in said identification, which including the template indexes and nesting relationships used in the formula;

S52: analyzing the formula objects according to the extracted information and in combination with the configuration file again, and reproducing them in the edit panels;

S53: after the user issues instruction of finishing the editing, regenerating the formula object identification, deleting the original formula object identification and the contents of the original formula, and writing the modified formula object identification and the formula contents.

The method for inserting objects into the PDF document provided by the present invention, wherein, said object is a special character and the insert panel is a character selection interface, exhibiting the manifestation of variant special characters in the form of tabulation.

The method for inserting objects into the PDF document provided by the present invention, wherein, further comprising following steps:

S6: when there does not exist the special characters to be inserted in the character selection interface, allowing the user to write the needed special characters in self-defining way and reminding the user to add them into a self-defining character library.

Compared with the existing technology, The method for inserting objects into PDF document proposed by the present invention can implement inserting the mathematical formulas and special symbols in the PDF document directly, and modifying them at any time according to the demands of users, which greatly facilitates to operate on the formulas and special character by the user, thereby the efficiency of creating and editing PDF document is enhanced.

### DESCRIPTION OF THE DRAWINGS

FIG. 1 is a flow diagram of the method for inserting objects into a PDF document of the present invention;

FIG. 2 is a flow diagram of modifying the inserted formulas of the present invention.

### DETAILED DESCRIPTION OF THE EMBODIMENTS

The description of the technical proposal of implementations of the present invention is given clearly and integrality as following. The given implementations are only part of the implementations to the present invention obviously, but not entire implementations. Based on the implementations of the present invention, all of the other implementations which get without devoting a creative work by the ordinary technicians in this field should be deemed to be within the scope of the present invention.

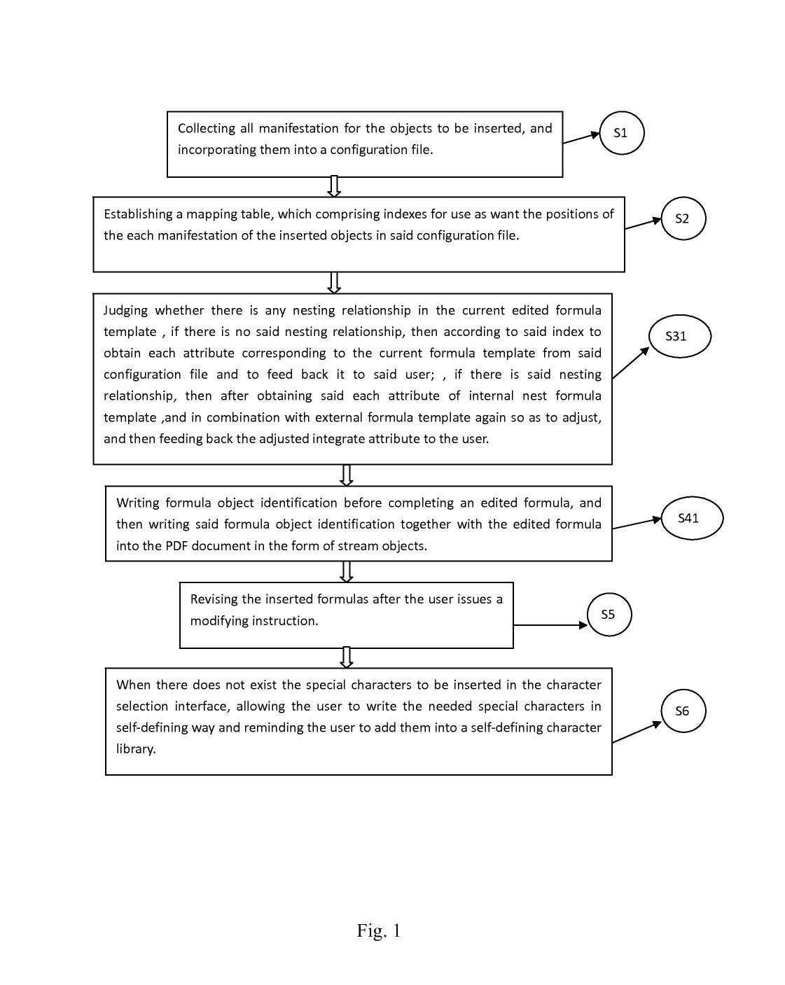

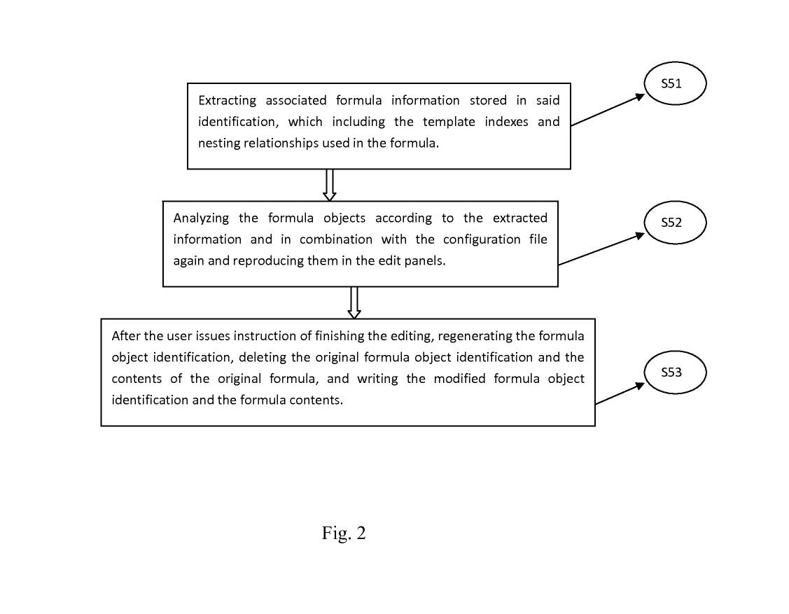

Please refer to FIG. 1 and FIG. 2, the present invention provides a kind of method for inserting objects in a PDF document, in particular refers to the method of inserting formulas and special characters in the PDF document. The detailed description of the technical proposal of implementations of the present invention is given from two aspects of inserting formulas and inserting special characters separately as following.

For inserting the formulas, the present invention mainly comprises the following steps:

(1) Collecting the instances of all a variety of formula objects and incorporating them into one configuration file, and loading them from the configuration file when executing. If necessary, the instances of all a variety of said collected formula objects can also be stored in databases. Due to the higher level of the security of the database, and more complex to operate, therefore the variety of formula objects can be just sorted and merged into the configuration files in the case without confidentiality. Wherein, the instances of the formula objects are comprised of variety of the formulas template, such as the template of the square formula []2 , and the template of fractional number formula []/[] and so on. A complete formula often contains multiple layers of the formula templates nesting, such as the square of one fraction, which includes the nesting of said template of square formula []2 and said template of fraction formula []/[], wherein, the template of square formula []2 is called the parent template, and the template of fraction formula []/[] is called the sub-template.

(2) Creating a mapping table, this is comprised of indexes and attributes of formula objects. Said index includes the specific location of said object in said configuration file, so that to be accurately obtained from the configuration file; said attributes of formula objects are divided into formula attributes and object attributes respectively. And object attributes are the general properties of said objects, which comprise the character pitch of the text, horizontal pantograph level, the array pitch, the font type of the text, the font size and the exhibition mode; and the formula attributes are used to determine the formula structures, which at least comprise: whether there is nesting or not, the total number of nesting layers and the indexes corresponding to the sub template for each nesting layer (for those with no nesting, the number of layer is 0, and the index of the sub template is empty);

(3) Creating an insert panel that is, an editing panel, which provide the user to edit formulas to be inserted in said panel. The concrete editing course is: when a formula template is chosen, judging whether the current editing template is the padding part of another template or not, and if the result is “no”, then various kinds of attributes corresponding to the current formula template, which are obtained from the configuration file according to the indexes, are fed back to the user; if the result is “yes”, then adjusting the properties in combination with the parent template after getting the various kinds of attributes of the sub template, and feed them back to the user.

The user can edit each reserved filling part of the formula template according to the requirement till the entire formula content is completed.

(4) Said editing panel is closed after the user issue a closing instruction, and the identification of formula objects are written, and then the adjusted formulas are written into the files following the identification in the form of stream objects.

Wherein, said formula object identity is a sign, which indicates that the object following it is a formula, wherein, the formula object identity at least contains the indexes of the templates, nesting relationships (if it has nest), it can be represented in the form of % + . . . + concretely. Because qualified PDF may ignore the content after % in one line automatically, so this can be directly saved in the current PDF file, meanwhile avoid the other readers which cannot support this function running normally.

(5) When the users need to modify the inserted formulas, the information concerned with said formula stored in the identities should be extracted, which includes the template indices, nesting relationships and so on; and then said formula objects are analyzed in combination with the configuration file according to the extracted information, and they are represented on the editing panel; the following modifying operations are as same as that in the inserting mode, the identities are regenerated after editing well and confirming the modifying, the original formula identities and formula objects are deleted, the modified identities and formulas are written.

The above is the detailed description of the embodiments about inserting objects into PDF document in the present invention. In addition, the present invention also provides method of inserting special characters in a PDF document, which comprises the following steps:

(1) Collecting the instances of all variety of special character objects, and sorting and merging them into one configuration file, and loading them from the configuration files when executing.

(2) Creating a selection interface for special characters. When the user clicks for inserting special characters, the interface pops up in a form of list; the codes of the special characters are returned directly corresponding to the indexes by the selected items when the user confirms the selection, then they are written into the PDF files.

(3) If there is no the codes responding to the special characters, or if the special characters are self-defined by the user, the objects are gotten from the configuration files by the indexes, and then they are written into the PDF files.

(4) If the descriptions of the special characters still do not exist in the configure files, the user can input them through the other means voluntarily, and is reminded to add it into the self defined special characters.

For the present invention described above are merely illustrative, is not intended to limit the invention, the ordinary technicians in this field can understand it as the following, the present invention of any modification, improvement, equivalent replacement, etc. where is within the spirit and principle, should be deemed to be within the scope of the present invention.

1. A method for inserting objects into a PDF document, wherein, comprising the following steps:
S1: collecting all manifestations of the objects to be inserted, and incorporating them into one configuration file;
S2: establishing a mapping table, which comprising indexes for use as wanting the positions of the each manifestation of the inserted objects in said configuration file;
S3: creating an insert panel, and after the user issues an instruction of inserting object,
Opening said insert panel for user to select or edit the objects to be inserted;
S4: after the user issues a closing instruction, closing said insert panel, and writing the contents edited in said edit panel by the user into the PDF document in the form of stream objects.

2. The method for inserting objects into a PDF document as claimed in claim 1, wherein, said objects are formulas, and their manifestations are all kinds of formula templates; said mapping table further including attributes, said attributes comprising formula attributes and general attributes; said formula attributes are used to determine formula structures, which comprising whether there are nests, the number of total nest layers and the corresponding index of sub-template of the each nest layer; Said general attributes comprising character pitch of the text, horizontal pantograph level, the array pitch, the font type of the text, the font size and the exhibition mode; the insert panel is an edit panel for the user to edit the formulas to be inserted.

3. The method for inserting objects into a PDF document as claimed in claim 2, wherein, said step S3 comprising:
S31: judging whether there is any nesting relationship in the current edited formula template, if there is no said nesting relationship, then according to said index to obtain each attribute corresponding to the current formula template from said configuration file and to feed back it to said user; if there is said nesting relationship, then after obtaining said each attribute of internal nest formula template, and in combination with external formula template again so as to adjust, and then feeding back the adjusted integrate attribute to the user.

4. The method for inserting objects in a PDF document according to claim 2, wherein, said step S4 comprising:
S41: writing formula object identification before completing an edited formula, and then writing said formula object identification together with the edited formula into the PDF document in the form of stream objects.

5. The method for inserting objects in PDF document as claimed in claim 2, wherein, further comprising the following step:
S5: revising the inserted formulas after the user issues a modifying instruction.

6. The method for inserting objects into a PDF document as claimed in claim 5 wherein, said step S5 comprising:
S51: extracting associated formula information stored in said identification, which including the template indexes and nesting relationships used in the formula;
S52: analyzing the formula objects according to the extracted information and in combination with the configuration file again, and reproducing them in the edit panels;
S53: after the user issues instruction of finishing the editing, regenerating the formula object identification, deleting the original formula object identification and the contents of the original formula, and writing the modified formula object identification and the formula contents.

7. The method for inserting objects into a PDF document as claimed in claim 1, wherein, said object is a special character, and the insert panel is a character selection interface, exhibiting the manifestation of variant special characters in the form of tabulation.

8. The method for inserting objects into a PDF document as claimed in claim 7, wherein, further comprising the following step:
S6: when there does not exist the special characters to be inserted in the character selection interface, allowing the user to write the needed special characters in self-defining way and reminding the user to add them into a self-defining character library.
